(19) United States
(12) Patent Application Publication
(10) Pub. No.: US 2016/0300288 A1
(43) Pub. Date: Oct. 13, 2016

(54) RECOMMENDATION SYSTEM

(71) Applicants: Philippe Jehan NEMERY DE BELLEVAUX, Shanghai (CN); Yingbin ZHENG, Shanghai (CN); Yan TAN, Shanghai (CN); Honggang WANG, Shanghai (CN); Yuanyuan CEN, Shanghai (CN)

(72) Inventors: Philippe Jehan NEMERY DE BELLEVAUX, Shanghai (CN); Yingbin ZHENG, Shanghai (CN); Yan TAN, Shanghai (CN); Honggang WANG, Shanghai (CN); Yuanyuan CEN, Shanghai (CN)

(21) Appl. No.: 14/682,127

(22) Filed: Apr. 9, 2015

(51) Int. Cl. G06Q 30/06; G06Q 30/02

(52) U.S. Cl. CPC G06Q 30/0631; G06Q 30/0282

(57) ABSTRACT

A framework for generating recommendations of an object based on classification is described herein. An object is classified into a class of an ordered classification arrangement based on a set of criteria. Recommendations are generated for the object to achieve an objective of a user based on user information of the user. The recommendations are personalized to the user based on the user information.

### TECHNICAL FIELD

The present disclosure relates generally to a framework for generating recommendations for an object. In particular, the framework relates to recommendations regarding a change in the performance of an object which may impact classification of the object while considering user preference information.

### BACKGROUND

Categorization of objects into ordered categories is widely used. The ordered categories, for example, rate objects into different rating categories, such as excellent, average and weak. As an example, suppliers, such as hotels and restaurants or employees may be categorized into rating categories. Such rating categories are useful to assist consumers (customers in the case of hotels and restaurants or employers in the case of employees) to access or make decisions related to the objects. The categorization of objects is important as it provides consumers with guidance as to which object to select. Categorization of objects is also important to suppliers (opposite of consumers) since they indicate vis-à-vis their position with respect to other suppliers. Such information can be used to implement marketing, sales, and operational strategies as well as for other purposes.

The present disclosure relates to providing recommendations to suppliers regarding ratings or classification based on supplier's preference information.

### SUMMARY

A framework for generating recommendations of an object based on classification is disclosed. In accordance with one aspect, the framework includes a computer-implemented method. The method includes classifying an object by a recommendation system. The object is classified into an ordered classification arrangement. The recommendation system assigns the object to a class in the ordered classification arrangement based on a set of criteria. Recommendations are generated for the object to achieve an objective of a user based on user information of the user. The recommendations are personalized to the user based on the user information.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures. Like reference numerals in the figures designate like parts.

FIG. 1 shows a simplified diagram of an exemplary environment or architecture;

FIG. 2 shows a high level illustration of an embodiment of a recommendation framework and actors;

FIG. 3 shows a simplified block diagram of an embodiment of a recommendation system;

FIG. 4 shows various types of marginal cost functions;

FIG. 5 illustrates classification of an object;

FIG. 6 illustrates improving classification of an object;

FIG. 7 illustrates maintaining classification of an object; and

FIGS. 8a-b show various pages of an exemplary implementation of a UI for a recommendation system.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of present frameworks and methods, and to thereby better explain the present frameworks and methods. Furthermore, for ease of understanding, certain method steps are delineated as separate steps; however, these separately delineated steps should not be construed as necessarily order dependent or being separate in their performance.

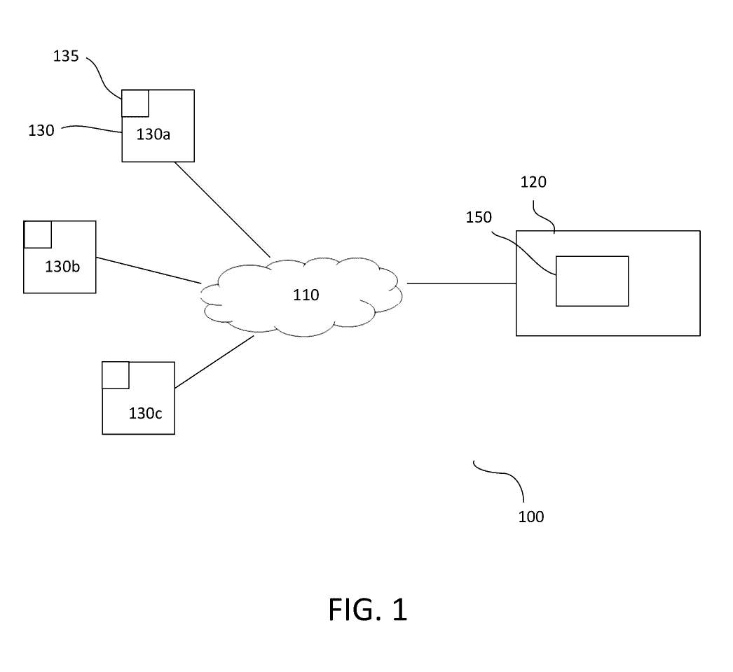

FIG. 1 shows a simplified diagram of an exemplary environment or architecture 100. The environment 100 may have a distributed architecture, such as a client-server architecture. The environment, in one implementation, includes a communication network 110. The communication network, for example, may be the World Wide Web (WWW or Web). Other types of communication networks or combination of networks may also be useful.

The environment includes a server 120. A server may be a computer with a memory and a processor. Various types of computers may be employed for the server. For example, the computer may be a mainframe, a workstation, as well as other types of processing devices. The memory of a computer may include any memory or database module. The memory may be volatile or non-volatile types of non-transitory computer-readable media, such as magnetic media, optical media, random access memory (RAM), read-only memory (ROM), removable media, or any other suitable local or remote memory component.

The server 120, for example, may include a plurality of interconnected servers. For example, the servers are interconnected by a communication network. The communication network may be an internet, an intranet, a local area network (LAN), a wide area network (WAN) or a combination thereof. The servers may be located in a single or multiple locations. The interconnected servers may be collectively referred to as a server.

The server 120 is configured to store and process resources requested by client devices 130. As shown, the environment includes client devices 130a-130c. It is understood that the environment may include other number of client devices. A client device may be a local computing device with, for example, a local memory and a processor. The memory may be volatile or non-volatile types of non-transitory computer-readable media, such as magnetic media, optical media, random access memory (RAM), read-only memory (ROM), removable media, or any other suitable local or remote memory component. Various types of processing devices may serve as the client device. For example, the client device may be a PC, a tablet PC, a workstation, a network computer, or a mobile computing device, such as a laptop, a tab or a smart phone. Other types of processing devices may also be used. It is understood that client devices may be different types of client devices.

The environment of the client device may be referred to as a local or native environment. A client (or end-user) and client device may be used interchangeably. For example, when referring to an end-user, it is understood that the end-user connects to the communication network using a client device. The client device may be referred to as the client side while the server may be referred to as the server side. It is understood that client devices need not be of the same type. For example, some client devices may be mobile devices running on different types of platforms, such as iOS or Android, while other client devices may be desktop or laptop computers.

In one implementation, the local environment of the client device includes a user agent 135. The user agent, for example, may be a web browser. The browser facilitates communication with the server. For example, the browser initiates communication to a web server by making a request for a specific resource using, for example, a Hypertext Transfer Protocol (HTTP) and the server responds with the content of that resource. Communication with the server, for example, may be through internet connection. The internet connection may be using a mobile telecommunication network, such as a 4G network. Other types of connections to the server may also be useful. An end-user may access the server by, for example, having a user account.

In other implementations, the environment 100 may be a cloud computing environment. In such cases, the interconnected servers 120 form a cloud. The cloud, for example, hosts and processes resources, such as applications and data, as well as other resources. Different servers may be used to store or process different resources. Such hosting and processing may be considered as cloud services. Various types of cloud services may be provided. The cloud services may be provided in a public, private or hybrid network. The cloud services may be provided by a cloud service provider. For example, the cloud services may be SAP HANA Cloud Platform provided by SAP SE. Other types of clouds and cloud providers may also be useful. A client device 130 accesses resources on the cloud using, for example, a browser 135. Other configurations of the environment may also be useful.

The environment 100 includes a recommendation framework 150. The recommendation framework, in one implementation, classifies objects. The objects may be animate or inanimate objects. Animate objects may be people, such as employees while inanimate objects may include hotels, restaurants, and universities. Other types of objects may also be useful. The objects are evaluated and classified into ordered classes or categories. The categories may be ordered from best to worst. For example, the categories may be ordered as high performance, average performance or low performance. Other types of classes, class labels, or granularity of classes may also be useful.

In one implementation, the recommendation framework generates recommendations to a user. The user may be associated with a product or service that is associated with an object. For example, the user may be a decision maker associated with the object that is evaluated or classified. The user, for example, may be a manager of a hotel or restaurant that is evaluated, employee of an evaluation, or employer or manager of an employee or employees being evaluated. Other types of users may also be useful.

The recommendations are related to the object. In one implementation, the recommendations change an aspect of the object related to the object's classification. The recommendations relate to a change in the performance of an object, such as improving or deteriorating performance of the object. The recommendations are based on a user's information or preferences. The recommendations provide insight to achieve objectives of the user. The recommendations may relate to improving the performance of an object. In one implementation, the improvement in performance improves classification of an object with minimum cost or effort. The recommendations may relate to deteriorating the performance of the object. The deterioration in the performance of the object, in one implementation, maintains classification while resulting in maximum savings. For example, the recommendations may be to provide a cost-effective improvement in classification and/or to reduce cost without affecting the current classification. Other types of recommendations which affect the performance and/or classification of an object may also be useful.

The recommendation framework may be a software tool. For example, the framework is a software tool that evaluates and classifies items or objects and generates recommendations regarding the classifications of the objects. The framework, in one implementation, resides on the server 120. Locating the framework in other locations may also be useful. For example, the framework may be a stand-alone framework and resides on an end-user device.

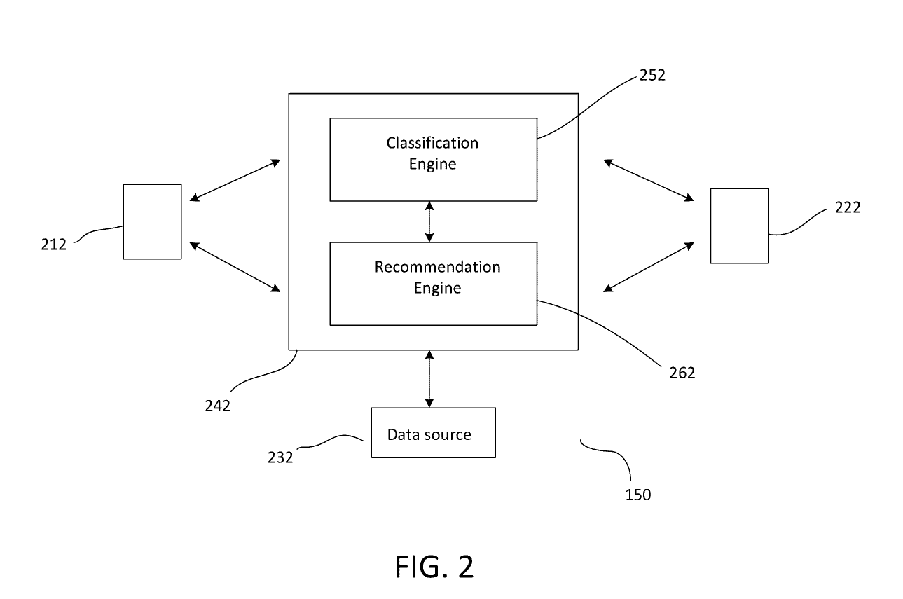

FIG. 2 is a high level illustration of an embodiment of a recommendation framework and actors. As shown, the framework includes a recommendation system 150. The recommendation system includes a data source 232 and an analyzer 242. The data source, for example, may be stored in a database, such as SAP HANA from SAP SE. Other types of databases may also be useful. As for the analyzer, it includes a categorization or classification engine 252 and a recommendation engine 262.

The recommendation framework includes first and second actors 212 and 222 of the framework. The actors may interact with the recommendation system using a user interface (UI). The UI may be part of a browser on an end-user device. In one implementation, the first actor is an evaluator of an object or objects of interest. For example, the first actor may evaluate a hotel. Evaluating other types of objects, such as restaurants or employees can also be performed.

An object is classified into a class based on its evaluation. The evaluation is based on a set of attributes or criteria. For example, the evaluation classifies the object into a category or classification of defined categories or classes. The defined categories may be an ordered category arrangement. The order of the categories may be based on quality, performance or other attributes or scale. For example, the categories may be labeled high performance, average performance or low performance. Other classes or labels and/or granularity of classes may also be useful. Rules which define classification may be determined by the evaluator. Such rules may include, for example, weighted-sum rules, sorting rules or other rules related to ranking objects based on criteria or ratings of each criterion from a set of criteria. The rules and criteria may be contained in the classification engine. For example, the classification engine may include a classification or evaluation model defining rules and criteria.

A classification model is employed to evaluate a type of object or objects of interest. For example, a hotel classification model may be employed to evaluate hotels, a restaurant classification model may be used to evaluate restaurants while an employee classification model may be used to evaluate employees. Other types of classification models may also be useful. The framework may be configured to evaluate one type of object based on the classification model. For example, the framework having a restaurant classification model is used to evaluate restaurants. In other implementations, the framework may be configured to evaluate multiple types of objects. For example, the framework may include multiple types of classification models for evaluating multiple types of objects. The framework may include a classification model builder for building classification models. For example, training data may be provided by the evaluator for the builder to build a classification model. The classification model builder may be configured to build different types of classification models. Other configurations of models and builders may also be useful.

The classification engine employs data from the data sources stored in, for example, the database for classifying the objects. The data, for example, include information of or related to the objects. The information may be factual information as well as information from surveys of customers or users. Factual information may include operating hours, space, and qualitative and quantitative information. The information may depend on, for example, the objects to be classified. The information may be introduced to the system by the evaluator. Other techniques or sources for introduction of the information to the system may also be useful.

A classification report may be generated by the classification engine. For example, the second actor, such as a user, may request the classification engine to generate a classification report. The user, for example, may be associated with or is the object of interest. For example, the user may be a hotel manager interested in the classification or rating of the hotel he manages or is an employee who is interested in the rating of his/her performance evaluation. Other types of users may also be useful.

The classification report includes the classification of the object based on a set of criteria, classification rules and data from the data sources. For example, in the case where the object is a hotel, it may have an overall classification categories of 1-star, 2-star 3-star and 4-star based on ratings of various criteria, such as size of room, amenities, number of rooms, price, location, proximity to public transportation, as well as other factors. On other hand, an employee performance evaluation may be classified as excellent, good or poor based on criteria such as timeliness, skills, productivity, quality of work product, quantity of work product, as well as other factors. The classification report may include the criteria or reasons on which the evaluation is based.

The recommendation engine, in one implementation, provides recommendations along with the classification report. The recommendations facilitate a user to achieve its objective. The objective may be to improve on the classification with minimal cost or effort or to maintain current classification while resulting in maximum cost savings. For example, in the case of a hotel manager, the recommendations may relate to improving from a 3-star to a 4-star classification with minimal cost or effort or to maintain current classification category which results in maximum cost savings. Other types of recommendations may also be useful. The recommendation provided is based on the objective of the user. The user may choose the objective via the UI. The user may choose to, for example, either improve classification with minimum cost or maintain classification with maximum savings via, for example, the UI. Other objectives may also be included.

In one implementation, the recommendations are based on user information. For example, the recommendations are personalized to a user based on information or settings provided by the user. Different users may have different user information. User information includes, for example, constraints, preference information, cost functions and costs. Providing other types of user information or settings may also be useful. The user information may be generalized as preferences or recommendation settings. The user may provide to the recommendation engine user information on which recommendations are based.

In one implementation, recommendations may be stored, for example, in the data source database. Retaining recommendations enables analysis of the quality and impact of recommendations over time. This may be employed to improve the quality of the recommendation engine.

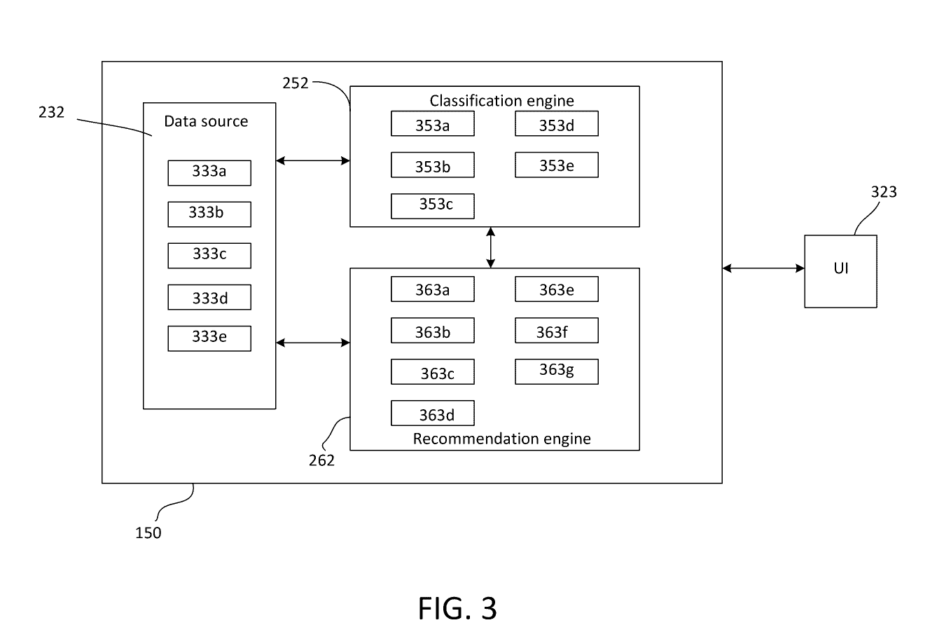

FIG. 3 shows a simplified block diagram of an embodiment of a recommendation system 150. As shown, the recommendation system includes a data source 232, a classification engine 252 and a recommendation engine 262. The recommendation system stores and retrieves data from the data source. For example, the data source may include data used by and generated by the classification and recommendation engines. A user may interact with the recommendation system through a UI 323 located in, for example, an end-user device. Other configurations of the recommendation system may also be useful.

The data source may include data from various data sources or modules 333a-e to facilitate classifying objects and generating recommendations. The recommendations are based on user information, such as user preference as well as other information. In one implementation, the data modules include training data module 333a, classification data module 333b, preference data module 333c, optimization data module 333d and scenarios data module 333e. Providing other types of data modules for the data source may also be useful. The data modules, for example, may be contained in a database, such as SAP HANA. Providing other types of databases for the data modules may also be useful.

The training data module includes a set of data used by the classification engine. The data set may be used by the classification engine to build and verify (e.g., determine the accuracy of) a classification model. Such data may include various criteria of interest for a type of object or object type to be classified. For example, in the case of a hotel, the criteria may be size, number of employees, cost, amenities, as well as other information of interest. The data may include historical data and/or third party data, such as survey and marketing data. Such data includes assigned or expected classifications of the objects. Other types of data for the data set may also be useful. The data set, for example, may be provided by the evaluator. Other techniques for providing the data set may also be useful. Different data sets may be provided in the training module to build different classification models. For example, the system may be employed to classify and provide recommendations for different types of objects.

The data set of the training module may include training and test or verification data. For example, the data set may include a training data sub-set and a test data sub-set. The structure of the training and test data may be similar. In one implementation, the training data is used to build the classification model while the test data is used to verify the classification model. The test data, for example, is used to test the accuracy of the classification model. In one implementation, the data of the training and test data sub-sets are mutually exclusive. For example, data used for building the classification model is not used for model verification, such as testing if the model is good or not good. Typically, the training data sub-set is larger than the test data sub-set.

As an example, assume the data set includes 100 employees. The training data sub-set may include data for 90 of the 100 employees which is used for building the classification model. The data of the remaining 10 employees will form the test data sub-set which is used for verifying the classification model. For example, the classification model is verified with the test data sub-set. If the classification model is accurate, the classification assigned by the model should match the expected or already assigned classification.

The classification data module includes data of a classification model. This may include possible parameters of the model. For example, parameters may include conditions in the decision trees, antecedents and consequences of rules, as well as other parameters of the classification model. For example, in the case of an employee classification model, an employee generating more than 20 customers and sales of more than 100K may be rated as an excellent employee while an employee with less than 5 new customers may be rated as a weak employee. The classification data module may include data of multiple classification models for classifying more than one type of objects.

The preference data module includes user information. For example, the preference data module includes user information from which recommendations are based. User information for different users may be contained in the preference module. Recommendations by the recommendation engine are based on user information of the user, for example, requesting the classification. In one implementation, the user information includes constraints, preferences, cost functions and costs. Providing other types of user information may also be useful.

Constraint information is related to impossible improvements. For example, an improvement of X % is not possible on a specific attribute or a decrease of more than X % is not possible on a specific attribute. As for preference information, it may include the preference of improving one criterion over another, minimizing or maximizing criteria or minimizing or maximizing costs or savings. Other preference information may also be useful. For example, preference information may include weights of attributes, cost shapes of functions as well as other types of information. Regarding cost functions, it relates to the cost associated with an increase of a specific attribute or criterion. Different attributes have different cost functions. For example, costs of improvements (marginal costs) are different for different attributes. Some attributes may be much more expensive to improve than other attributes. Additionally, the cost function of an attribute may not be linear. For example, a cost function may be convex or concave. Other types of cost functions may also be useful. For example, the cost function may be a step function. Cost information may be used to facilitate decision making regarding which recommendations to implement.

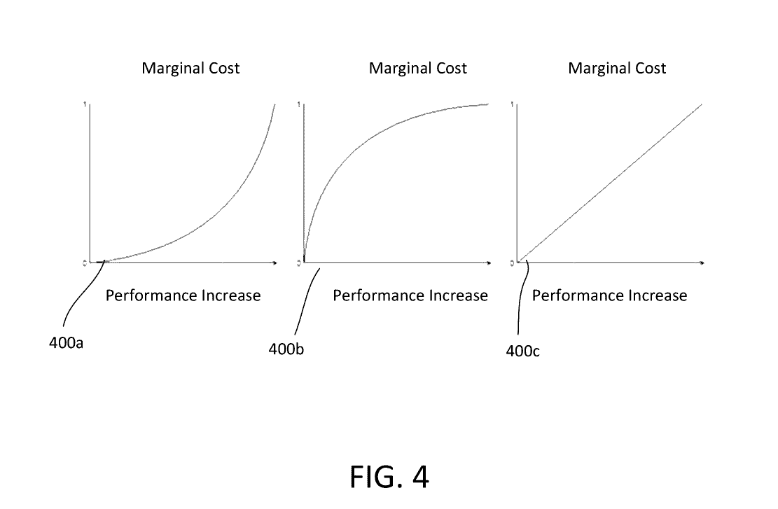

FIG. 4 shows various types of marginal cost functions 400a-c. Cost function 400a is a convex cost function, cost function 400b is a concave cost function while cost function 400c is a linear cost function. The various costs functions, for example, may express how the cost increases in relation to the improvement on the considered criterion. Other types of cost functions, such as step functions, may also be employed.

Referring back to FIG. 3, the optimization data module includes optimization data regarding improvements or deteriorations. Optimization data relates to, for example, simulation results of costs or savings associated with different attributes or criteria. For example, cost of improvement to the next level are calculated for different attributes, or amount of savings achieved while maintaining classification level are calculated for different attributes. As for the scenario data module, it contains comparison data for different optimization results, leading to different cost. The comparison data is based on different input parameters. For example, a user may change the cost quantity by changing the cost function. Scenario data, for example, may be derived from a “what if” analysis performed by the recommendation engine.

The classification engine includes various modules for classifying an object of interest or object type. In one implementation, the classification engine includes a data controller module 353a, a classifier builder module 353b, a model controller module 353c, an evaluation module 353d and a classifier module 353e. Providing other modules for the classification engine may also be useful.

The data controller module controls data flow between it and the database containing the data sources. For example, the data controller module defines which data is retrieved from the database and where data generated by the classification engine is saved in the database.

As for the classifier builder module, in one implementation, it generates a classification model from training data in the database. For example, the classifier builder module uses training data from the training data module in the database to build the classification model. Various types of builder modules may be employed to build the classification model. For example, builder module may employ inference techniques, such as inferring rules from the training data to build the classification model.

The model controller module manages different versions of a model. For example, more than one version of the model may be developed. Different models may have different accuracy. The model controller module may invoke the evaluation module to evaluate the quality of a classification model or models. In addition, the model controller module may include different types of models for classifying different types of objects.

The evaluation module computes the accuracy of the classification model. For example, test data from the test data sub-set in the training data module may be provided to the evaluation module to evaluate the accuracy or quality of a classification model. As for the classifier module, it classifies a new record of an object based on the invoked classification model. For example, the classification model from the data source is used or invoked by the classifier module. The classifier module classifies the object into a category based on a score using the model. The classification model can be rebuilt and instantiated based on the new record. For example, a user may invoke retraining the model when new or additional training data is available. As an example, an evaluation of a new hotel may be added to the existing training data for rebuilding the model.

A classification model evaluates an object (e.g., aᵢ based on a set of criteria F (e.g., F={f₁, . . . , fⱼ, . . . , f_{q}}). The results of an evaluation may be expressed in a scale, such as a verbal scale, numerical sale, ratings as well as other types of scales. The evaluations of the object based on each criterion may be aggregated based on the classification model.

In one implementation, the classification model employs a weighted sum technique. Other types of classification models, such as those using UTADIS, FlowSort, or Electre-Tri techniques, may also be useful. In a weighted sum technique, a global (weighted) score U(aᵢ) of object aᵢ is computed. The weighted score of object aᵢ is computed using equation 1 as follows:

∀aᵢεA:U(aᵢ)=Σⱼ₌₁^{q}(wⱼ*(fⱼ(aᵢ))) (Equation 1),

where

wⱼ represents the weight associated to criterion fⱼ, and

fⱼ(aᵢ) represents the evaluation of the object on the criterion fⱼ.

Generally, fⱼ(aᵢ) represents a normalized score or a utility score.

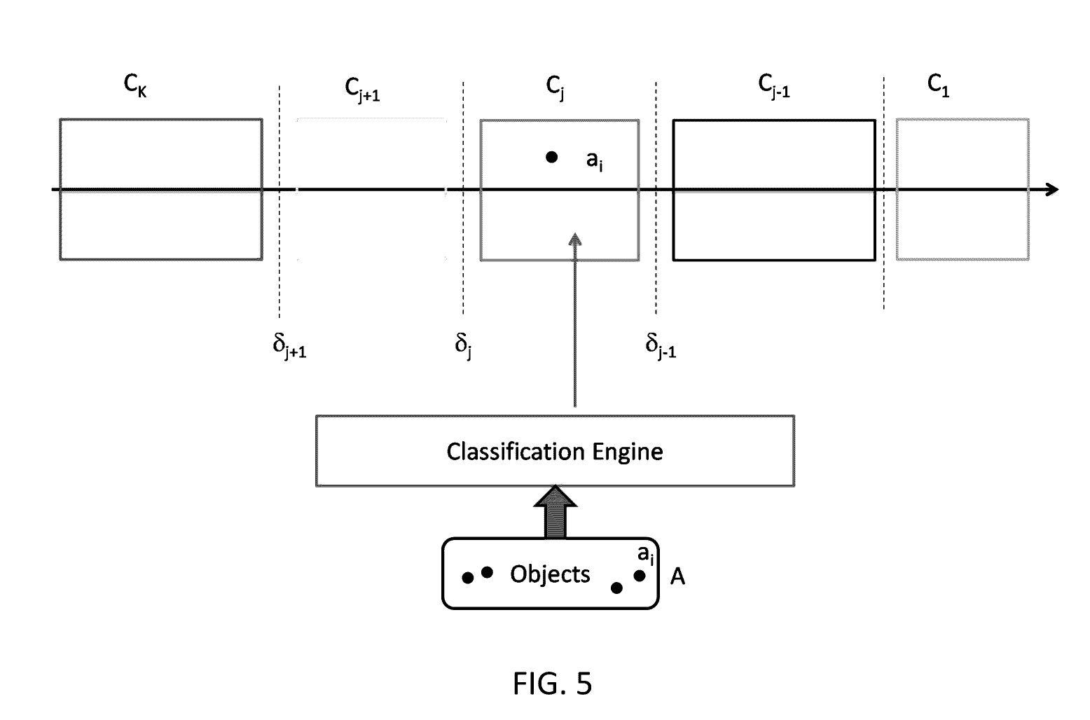

Based on the weighted score, an object aᵢ is assigned into a category. For example, category Cⱼ will be defined by the thresholds δⱼ and δⱼ₋₁. For example, aᵢ is placed into category Cⱼ if the condition δⱼ≦U(aᵢ)<δⱼ₋₁ is satisfied. In this case, Cⱼ₋₁ represents a next higher category while Cⱼ₊₁ represents a next lower category. FIG. 5 illustrates the classification of an object. As shown, an object aᵢ from a set of objects A is classified into Cⱼ since the condition that δⱼ≦U(aᵢ)<δⱼ₋₁ is satisfied.

Returning to FIG. 3, the recommendation engine includes various modules for generating recommendations of an object of interest or object type. In one implementation, the recommendation engine includes a data controller module 363a, a preference information module 363b, a constraints module 363c, a cost builder module 363d, a goal module 363e, a scenario module 363f and a solver module 363g. Providing other modules for the recommendation engine may also be useful.

The data controller module controls data flow between it and the database containing the data sources. The controller determines which data is retrieved from the database and where data generated by the recommendation engine is saved in the database.

In one implementation, user information, such as preference information, constraints, costs and goals are retrieved from the database and passed to the corresponding modules in the recommendation engine. The user information, for example, is used by the solver module. In one implementation, preference information, constraints, costs and goals are translated into constraints and objective functions. This is performed by the cost builder module, preference information module, constraints module and goal module.

The user information is used by the solver module to generate recommendations. Recommendations may be on how to increase classification with minimal cost or efforts or how to maintain classification with maximum cost savings. For example, the solver module may indicate how to reach a better classification at the minimum cost, such as, in the case of an employee, how to improve the evaluation in order to make the employee a more efficient employee and thus a better employee. Other types of recommendations may also be useful.

The solver, for example, may be a linear solver. Other types of solvers, such as mixed integer solver, including heuristic analyzers, may also be useful. The type of solver may depend on the constraints, cost functions and variables defined by the system.

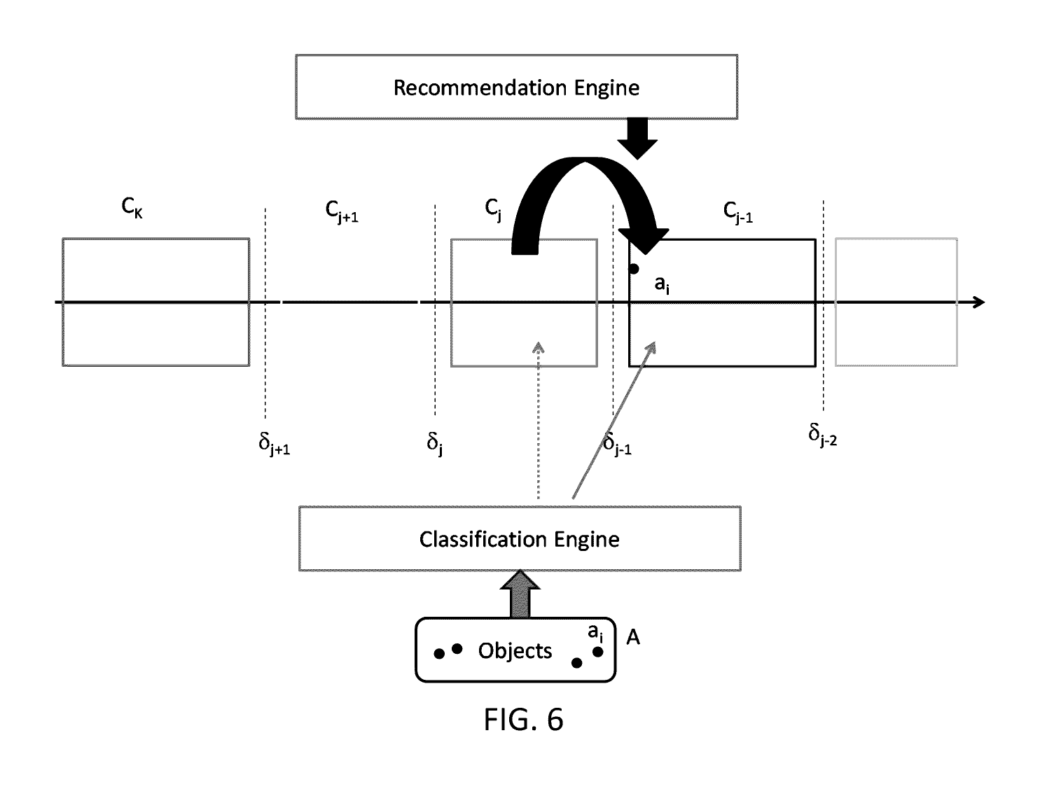

As discussed recommendations may be to improve or deteriorate performance of an object. In one instance, a decision maker (user) might be interested in improving performance to improve the categorization from one category to a next higher category while spending the minimum cost or effort. For example, hotel management of a hotel may desire to increase the hotel rating from a 3-star to a 4-star rating. FIG. 6 illustrates improving classification of an object. As shown, an object aᵢ from a set of objects A is classified currently into Cⱼ since δⱼ≦U(aᵢ)<δⱼ₋₁. To improve to the next higher classification category Cⱼ₋₁, U(aᵢ) is increased so that it is (at least) greater or equal to δⱼ₋₁. For example, U(aᵢ) is increased so that it is between δⱼ₋₁ and δⱼ₋₂. Providing recommendations to improve multiple classifications with minimum cost may also be useful. When improving multiple levels, the cost is greater than the cost for improving to the next higher level.

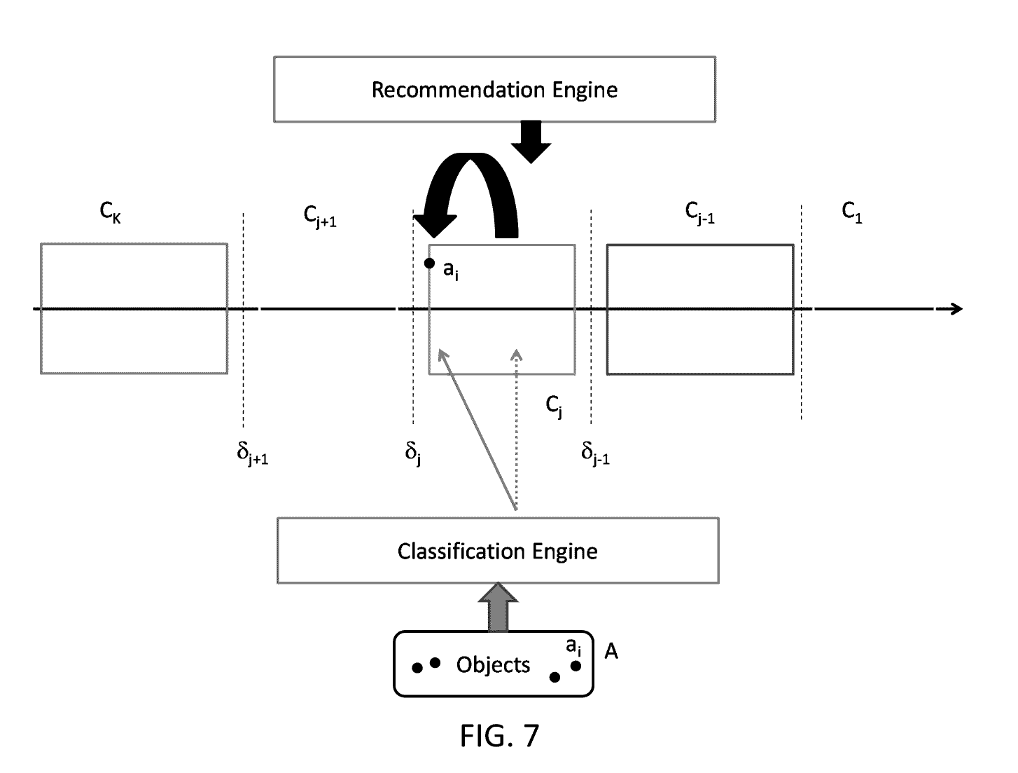

In another case, a decision maker (user) might be interested in deteriorating or reducing performance to save costs. In one implementation, deteriorating performance maintains current classification while achieving the largest cost savings. For example, the management of a hotel may desire to reduce costs of running the hotel while maintaining the current rating of a 3-star hotel. FIG. 7 illustrates maintaining classification of an object. As shown, an object aᵢ from a set of objects A is classified currently into Cⱼ since δⱼ₋₁≦U(aᵢ)<δⱼ. Savings can be made so long U(aᵢ) is ≧δⱼ, as indicated by dotted arrow. Providing recommendations to decrease in one or more classification levels with maximum savings may also be useful. When decreasing a classification level, savings are greater than that of maintaining the current classification level.

Recommendations of an object (aᵢ), in one implementation, may be expressed generally, by equation 2 as follow:

fⱼ(aᵢ^{+/-})=fⱼ(aᵢ)+/−Δᵢⱼ,∀ⱼ (Equation 2),

where
Δᵢⱼ≧0 represents the increase/decrease in performance of an object aᵢ by criterion fⱼ.
   Equation 2 may be performed for each criterion in the set (∀ⱼ).

For performance improvement of an object to improve a category or classification, recommendations may be specifically expressed by equation 3a as follows:

fⱼ(aᵢ⁺)=fⱼ(aᵢ)+Δᵢⱼ,∀ⱼ (Equation 3a).

To improve performance so as to improve in category or classification level, for example, from Cⱼ to Cⱼ₋₁, the condition δⱼ₋₁≦U(aᵢ⁺)<δⱼ₋₂ needs to be satisfied. Improving multiple classification levels may be achieved by modifying the condition.

As for deteriorating the performance of an object to maintain current category or classification, recommendations may be expressed specifically by equation 3b as follows:

fⱼ(aᵢ⁻)=fⱼ(aᵢ)−Δᵢⱼ,∀ⱼ (Equation 3b).

To deteriorate the performance to maintain current category or classification level, for example, the condition δⱼ≦U(aᵢ⁻)<δⱼ₋₁ needs to be satisfied. Deteriorating performance to reduce classification level or levels may also be achieved by modifying the condition.

In the case of improving category or performance, not every performance improvement (increase) is possible in practice. Constraints may be placed on a criterion. Different criteria may have different constraints. Not all criteria may have constraints. For example, one or more may have while others may not. In one implementation, a criterion may have minimum increase and maximum increase constraints. The minimum increase constraint, where performance cannot be decreased, is defined by equation 4 as follows:

fⱼ(aᵢ⁺)≧(aᵢ) or Δᵢⱼ≧0,∀i,j (Equation 4).

The maximum increase constraint, which is the upper limit of an improvement on performance, is defined by equation 5 as follows:

Uⱼ≧fⱼ(aᵢ⁺) or Uⱼ−fⱼ(aᵢ)≧Δᵢⱼ≧0,∀i,j (Equation 5),

where

Uⱼ is the upper limit on criterion j.

Other types of constraints may also be included. For example, feasibility constraints may be added to the optimization model. Feasibility constraints relate to improvements which are impossible or very difficult due to, for example, technical reasons.

An increase in performance is associated with incurring cost. However, different criteria will have different costs associated. For example, a decision maker may have a choice between more than one criterion from which current classification can be increased or improved. Marginal increase in one criterion over another may result in different costs. For example, the increase in global cost or global cost score E( ) may be different based on which criterion is chosen.

In one implementation, weights are used as a scaling factor to make the criteria commensurate with each other. For example, different cost weight factors w are provided for different criteria. The cost weight factors wⱼ^{inv} may be used to commensurate marginal cost on each criterion j. The weight factors are specified by the user. For example, the weight factors are provided by the user as user preference information.

As already discussed, different criteria may have different cost functions E( ). For example, a criterion may have a linear or a non-linear cost function E( ), such as a convex or concave cost function. Other types of cost functions may also be useful. The cost function of each criterion is defined, for example, by the user. The cost functions may be provided by the user as user preference information. Assuming that the criteria are independent and additive, the global cost function can be defined by equation 6 below:

∀aᵢεA:E(Δaᵢ⁺)=Σⱼ₌₁ⁿwⱼ^{inv}*Eⱼ(Δᵢⱼ) (Equation 6),

where

wⱼ^{inv} is weight associated to the cost (effort) on criterion fⱼ,

Eⱼ( ) is cost function for criterion j, and

Δᵢⱼ is the increase of the performance for criterion j on object aᵢ.

When improving performance to improve classification, the global cost function E( ) is preferably minimized. For example, the incremental cost to improve classification is minimized or is at the lowest. The system, for example, determines which criterion or criteria to recommend to achieve an improvement in classification with the minimum cost increase while satisfying the constraints. In one implementation, the system determines which Δᵢⱼ produces the minimum generated cost E(Δa*ᵢ) while satisfying constraints. In one implementation, the generated costs E(Δa*ᵢ) for Δᵢⱼ of criteria are calculated. For example, the generated cost for Δᵢⱼ of each criterion in the set of criteria is calculated. Determining the generated costs for different Δᵢⱼ, in one implementation, facilitates improvement or cost recommendations to be generated by the system.

In one implementation, the generated cost may be solved using a linear programming system. For example, if the cost functions are linear, the solver may employ a linear programming system. Other types of solvers may also be useful. For example, the solver may employ multi-objective or heuristic systems. Such systems, for example, may be used to solve non-linear cost functions. Providing a solver which employs multiple systems or techniques may also be useful.

The improvement recommendation provided by the system may be associated with the criterion which results in the lowest E(Δa*ᵢ) while satisfying the constraints. In some cases, the system may provide more than one improvement recommendations. For example, the system may provide to the decision maker the criteria which generate the 5 lowest costs while satisfying the constraints. Providing a complete list of generated costs which satisfy the constraints may also be useful. For example, this allows the decision maker to decide which improvement to select. In other cases, the system may provide an improvement recommendation which may result in improving more than one criterion (e.g., multiple criteria) to achieve the lowest generated cost or costs. Other configurations of recommendations may also be useful. Through the use of weights and other preference information, the recommendation is personalized to the user or decision maker. A user may select which output to produce. For example, the UI may include an option for the user to select which output to produce.

In the case of deteriorating performance which results in cost savings, constraints may be imposed. For example, constraints may be placed on a criterion. Different criteria may have different constraints. Not all criteria may have constraints. For example, one or more may have while others may not. In one implementation, a criterion may have minimum decrease and maximum decrease constraints. The minimum decrease constraint, where performance cannot be increased, is defined by equation 7 as follows:

fⱼ(aᵢ⁻)≦fⱼ(aᵢ) or Δᵢⱼ≧0∀i,j (Equation 7).

The maximum decrease constraint, which is the lower limit of a decrease in performance, is defined by equation 8 below:

Lⱼ≦fⱼ(aᵢ⁻) or fⱼ(aᵢ)≧Δᵢⱼ≧Lⱼ,∀i,j (Equation 8),

where

Lⱼ is the lower limit on criterion j.

Other types of constraints may also be included. For example, feasibility constraints may be added to the model. Feasibility constraints relate to cost savings which are impossible or very difficult due to, for example, technical reasons.

Similar to category improvement, the resulting saving on a marginal decrease in performance may be different for different criteria. In one implementation, weights are used as a scaling factor to make the criteria commensurate with each other.

For example, different savings weight factors w are provided for different criteria. The savings weight factors wⱼ may be used to commensurate marginal savings for each criterion j. The weight factors are specified by the user. For example, the weight factors are provided by the user as user preference information using the UI.

Different criteria may have different savings functions S( ). For example, a criterion may have a linear or a non-linear savings function S( ), such as a convex or concave cost function. The savings functions may be similar to cost functions E( ). For example, the savings functions may be the opposite of cost functions. The savings function of each criterion is defined, for example, by the user. The savings functions may be provided by the user as user preference information. Assuming that the criteria are independent and additive, the global savings function can be defined by equation 9 below:

∀aᵢεA:S(Δa*ᵢ)=Σⱼ₌₁^{q}wⱼ*S(Δᵢⱼ) (Equation 9),

where,

wⱼ is the weight associated to the saving on criterion fⱼ,

Sⱼ( ) is the saving function on criterion j, and

Δᵢⱼ is the decrease of the performance by criterion j of object aᵢ.

When deteriorating performance to maintain or decrease classification, the global saving function S( ) is preferably maximized. For example, the savings resulting from reducing performance while maintaining or decreasing classification are maximized or at the highest. The system, for example, determines which criterion or criteria to recommend to achieve maximum savings to maintain or decrease classification, while satisfying the constraints. In one implementation, the system determines which Δᵢⱼ produces the maximum savings S(Δa*ᵢ) while satisfying the constraints. In one implementation, the savings S(Δa*ᵢ) for Δᵢⱼ of the criteria are calculated. For example, the savings for Δᵢⱼ of each criterion in the set of criteria is calculated. Determining savings for different Δᵢⱼ, in one implementation, facilitates deterioration or savings recommendations to be generated by the system.

In one implementation, the cost savings may be solved using a linear programming system. For example, if savings functions are linear, the solver may employ a linear programming system. Other types of solvers may also be useful. For example, the solver may employ multi-objective or heuristic systems. Such systems, for example, may be used to solve non-linear savings functions. Providing a solver which employs multiple systems or techniques may also be useful.

The cost savings recommendation provided by the system may be associated with the criterion which results in the highest S(Δa*ᵢ) while satisfying the constraints. In some cases, the system may provide more than one cost savings recommendations. For example, the system may provide to the decision maker the criteria which generate the 5 highest cost savings while satisfying the constraints. Providing a complete list of cost savings which satisfy the constraints may also be useful. For example, this allows the decision maker to decide which reduction in performance to select. In other cases, the system may provide a cost savings recommendations which may result in deteriorating more than one criterion (e.g., multiple criterion) to achieve the highest cost savings. Other configurations of recommendations may also be useful. Through the use of weights and other preference information, the recommendation is personalized to the user or decision maker. A user may select which output to produce. For example, the UI may include an option for the user to select which output to produce.

The scenarios module enables a user to generate different scenarios by changing parameters. The scenarios module, for example, enables a user to simulate results based on real time changes to parameters by the user. The user may change or define different parameters, such as preferences, cost or savings functions, which criteria to improve or reduce performance. The parameters may be provided using the UI. The results of the changes may be visualized by the user. For example, simulation results may be visualized in the UI. This may facilitate in making decisions regarding future investments or restructuring. The scenarios module may also provide insights as to what strategy to take based on, for example, objectives and conditions.

As discussed, a user may interact with the recommendation system through a UI. For example, the user may enter user information to the system, change parameters to generate different scenarios as well as other functions provided by the system.

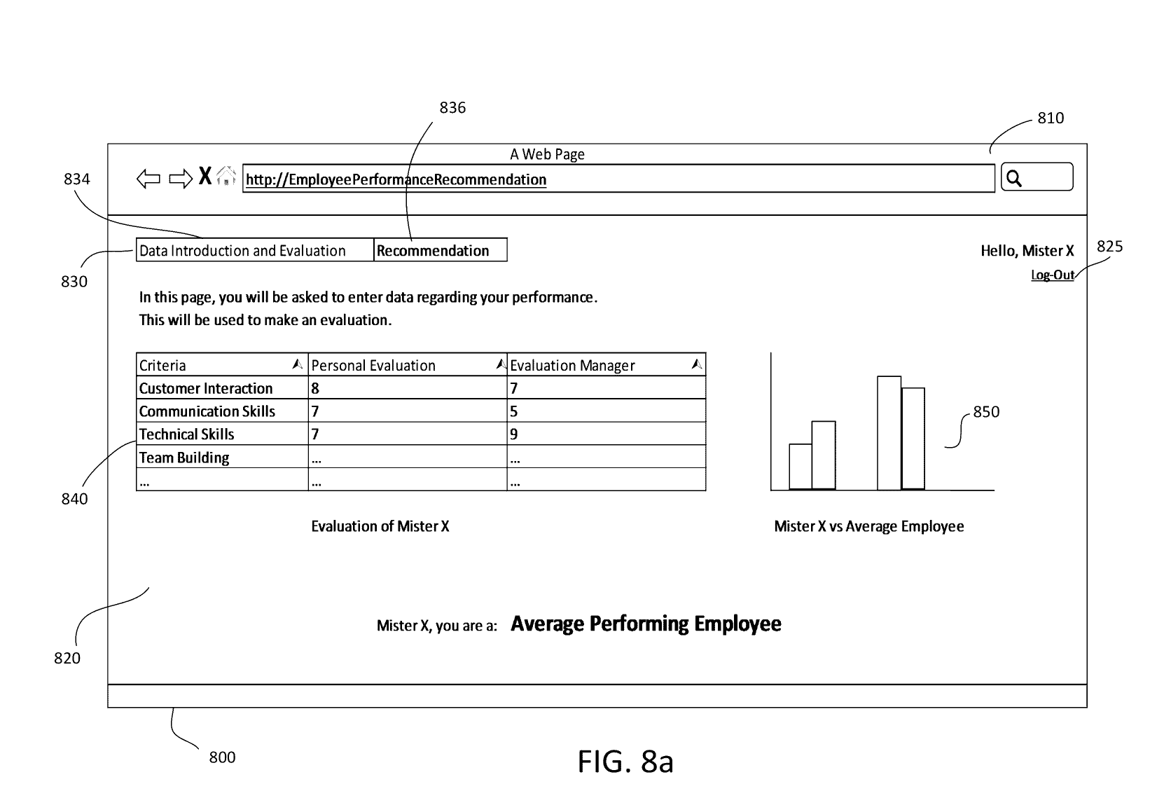

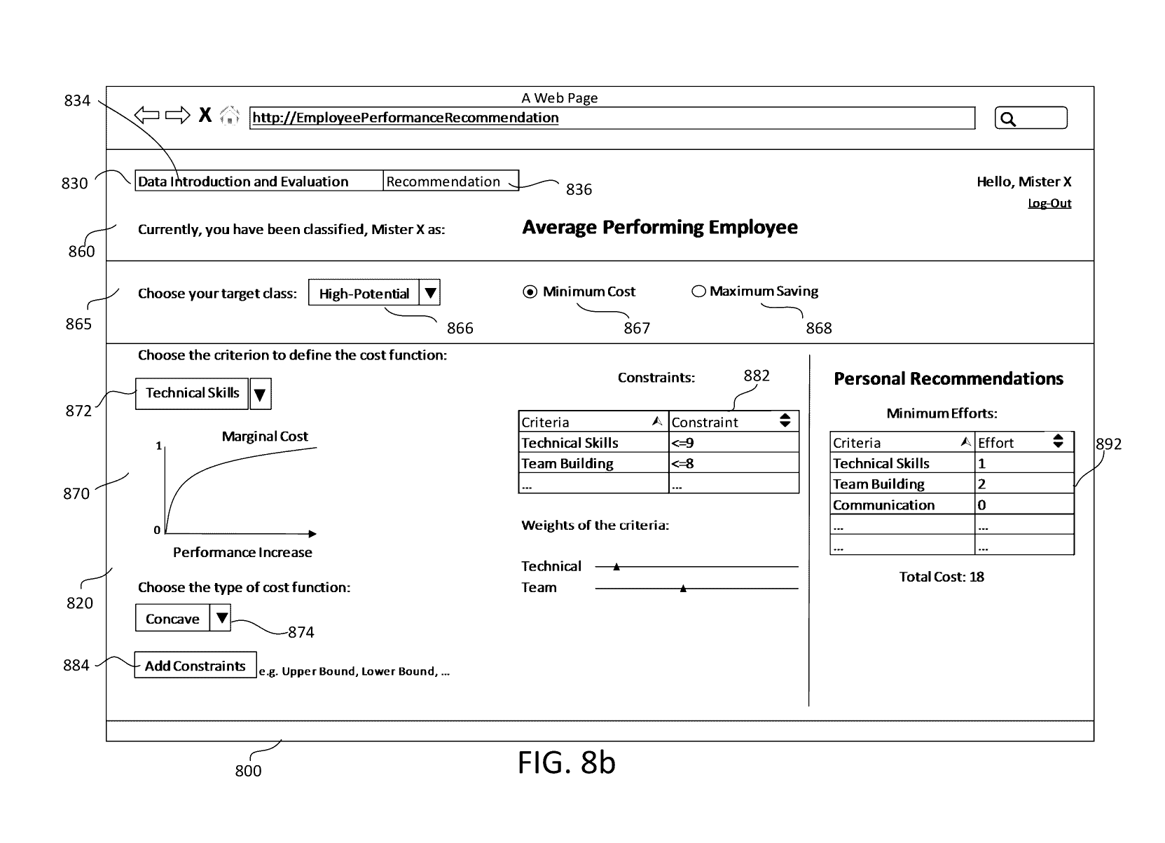

FIGS. 8a-b show various pages 800 of a UT of an implementation of a recommendation system. The UI facilitates in navigating the recommendation system as well as displaying appropriate information to the user. In one implementation, the recommendation system is for classifying and providing recommendations for employees of a company. Other types of recommendation systems may also be useful. For example, providing recommendations for other types of objects, such as restaurants, hotels or universities, may also be useful. Providing recommendation systems which can generate recommendations for multiple types of objects may also be useful. The recommendation system may be operated by a service provider. For example, users may subscribe to the service. In other instances, the recommendation system may be dedicated to a company, providing recommendations for its users. Other configurations of recommendation systems may also be useful.

The UI facilitates in navigating the recommendation system as well as displaying appropriate information to the user. The page includes a web navigation bar 810. For example, this enables a browser to access the system by entering the appropriate URI or web link of the system. The page may also include a menu bar (not shown) to facilitate navigating the recommendation system. As shown, the page includes a main panel 820.

The main panel includes an access function 825. For example, a user enters username and password to access the recommendation system. When a user is finished, a user may select to logout of the system. When a user is logged in, the user access his/her information in the recommendation system. Depending on the type of user, the user may access information of other users. For example, a manager may access information of various employees under his report. Accessing other information may also be useful. In the example, the user Mister X is logged in.

In one implementation, the main panel includes a selector 830. The selector enables the user to select different functions of the recommendation system. As shown, the selector includes a data introduction and evaluation function 834 and recommendation function 836. As shown, the data introduction and evaluation function is selected. Selecting the data introduction and evaluation page displays functions related to data introduction and evaluation. Criteria ratings 840 are provided by the evaluator, such as the employee's manager. For example, a manager may access the system and select the employee for which criteria information is to be entered. The system may also allow the employee to provide criteria information.

Based on the criteria information, the system classifies the object. In this case, Mister X is classified as an average performing employee. The display panel may also provide a chart 850. The chart be a graphical depiction of the different criteria. Other types of charts for displaying other types of information may also be useful.

Referring to FIG. 8b, the recommendation page of the UI is shown. The recommendation page includes a main page 820 having various sections. In one implementation, the main page includes a performance section 860 which indicates the current classification of the object. For example, the employee evaluation indicates that the employee is an average performing employee. A classification selection section 865 is also included in the main page. The classification selection section provides a target classification selection 866, enabling the user to select the desired target classification of the object.

As shown, the user selects the target classification of his employee evaluation. The target classification selected, for example, is high performance classification, which is the next higher classification from his current average performance classification. The user may also select to improve multiple categories. In some instances, a user may select maintaining or decreasing current classification. The user may select minimum cost or maximum savings options 867 and 868, depending on whether improving current classification or maintaining or decreasing current classification is desired. In some implementation, the minimum cost or maximum savings options is selected automatically based on classification selections. For example, the system may automatically select the minimum cost option when the employee chooses a target classification which is higher than the current classification.

A user information section 870 is provided. The user may input user information related to criteria in the user information section. A criteria selection box 872 enables a user to select a criterion which information is to be input. For example, the technical skill criterion is selected. The user may input the type of cost function in a cost function selector 874 for the selected criterion. In this case, the user selected a concave cost function for the selected criterion. The concave cost function may be displayed. Selecting other types of cost functions may also be useful. Input parameters related to the cost function may be provided by the user. For example, in the case of a concave function, the exponent and minimum and maximum may be provided. Other types of parameters may be provided for other types of cost functions. For example, in the case of a step function, steps and values may be provided.

A constraints table 882 may be displayed in a constraint section of the main panel. The constraints table lists the constraints for the various criteria. As shown the constraints table include two constraints. A user may add constraints by, for example, clicking on an add constraint button 884. A weighting section is provided in which a user may input weights related to the criteria. For example, as shown, weights for two different criteria are provided. The weights are normalized weights. For example, the sum of the weights is equal to 1. Based on the user information provided, the recommendation engine displays recommendations in the recommendation section. For example, the recommendation engine displays a recommendation table 892 for improving classification from average performance to high performance. The cost shown is the real cost converted by the system using the cost functions. Other techniques for displaying costs may also be useful. For example, costs may be displayed next to each criterion.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A computer-implemented method for generating recommendations of an object based on classification comprising:
classifying an object by a recommendation system into an ordered classification arrangement, wherein the recommendation system assigns the object to a class (current class) in the ordered classification arrangement based on a set of criteria;
generating a recommendation for the object to achieve an objective of a user based on user information of the user, and
wherein the recommendation is personalized to the user based on the user information.

2. The computer-implemented method of claim 1 wherein the recommendation comprises improving performance of the object.

3. The computer-implemented method of claim 2 wherein improving performance improves the current class to a higher class in the classification system of the object with minimum cost.

4. The computer-implemented method of claim 1 wherein the recommendation comprises deteriorating performance of the object.

5. The computer-implemented method of claim 4 wherein deteriorating performance maintains the current class in the classification system with maximum savings.

6. The computer-implemented method of claim 4 wherein deteriorating performance decreases the current class to a lower class in the classification system with maximum savings.

7. The computer-implemented method of claim 1 wherein the user information is associated with each criterion in the set of criteria.

8. The computer-implemented method of claim 7 wherein the user information comprises:
constraints;
weights; and
cost functions.

9. The computer-implemented method of claim 8 wherein the cost functions comprise linear cost functions, non-linear cost functions or a combination of both.

10. The computer-implemented method of claim 9 wherein generating recommendation comprises solving the cost functions of the criteria in the set of criteria using a solver.

11. The computer-implemented method of claim 10 wherein the solver comprises a linear solver, a mixed integer solver or a combination thereof.

12. The computer-implemented method of claim 1 wherein classifying the object is according to classification rules defined by an evaluator of the object.

13. The computer-implemented method of claim 1 comprising generating a classification model for classifying the object.

14. The computer-implemented method of claim 13 wherein generating the classification model is based on training data comprising historical information.

15. The computer-implemented method of claim 13 comprising verifying the classification model using test data comprising historical information.

16. A recommendation system comprising:
a data source, the data source includes data;
a classification engine, the classification engine includes a classification model for evaluating an object (evaluated object) based on a set of criteria and assigns the evaluated object into a class (current class) in an ordered classification arrangement;
a recommendation engine for generating a recommendation for the object to achieve an objective of a user based on user information of the user; and
wherein the recommendation is personalized to the user based on the user information.

17. The a recommendation system of claim 16 wherein the recommendation engine comprises:
a recommendation engine data controller, wherein the recommendation engine data controller controls flow of data between the recommendation engine and the data source; and
a solver module for solving cost of each criterion in the set of criteria based on user information to facilitate generating the recommendation.

18. The recommendation system of claim 17 wherein the recommendation comprises selecting one recommendation from a group of recommendations comprising:
improving performance of the object, wherein improving performance improves the current class to a higher class in the classification system of the object with minimum cost;
deteriorating performance of the object, wherein deteriorating performance maintains the current class in the classification system with maximum savings; and
deteriorating performance of the object, wherein deteriorating performance decreases the current class to a lower class in the classification system with maximum savings.

19. A non-transitory computer-readable medium having stored thereon program code, the program code executable by a computer for generating recommendations of an object based on classification comprising:
classifying an object by a recommendation system into an ordered classification arrangement, wherein the recommendation system assigns the object to a class (current class) in the ordered classification arrangement based on a set of criteria;
generating a recommendation for the object to achieve an objective of a user based on user information of the user, wherein
the user information is associated with each criterion in the set of criteria, and
the user information comprises
constraints,
weights, and
cost functions; and
wherein the recommendation is personalized to the user based on the user information.

20. The non-transitory computer-readable medium of claim 19 wherein the recommendation comprises selecting one recommendation from a group of recommendations comprising:
improving performance of the object, wherein improving performance improves the current class to a higher class in the classification system of the object with minimum cost;
deteriorating performance of the object, wherein deteriorating performance maintains the current class in the classification system with maximum savings; and
deteriorating performance of the object, wherein deteriorating performance decreases the current class to a lower class in the classification system with maximum savings.
